(19) United States
(12) Patent Application Publication
(10) Pub. No.: US 2015/0350371 A1
(43) Pub. Date: Dec. 3, 2015

(54) CACHING AND SYNCING MECHANISMS FOR A CLOUD LIBRARY

(71) Applicant: Apple Inc., Cupertino, CA (US)

(72) Inventors: Nicholas J. Woods, San Francisco, CA (US); Julien J. Jalon, San Francisco, CA (US)

(73) Assignee: Apple Inc., Cupertino, CA (US)

(21) Appl. No.: 14/292,012

(22) Filed: May 30, 2014

(51) Int. Cl. H04L 29/08; G06F 17/30

(52) U.S. Cl. CPC H04L 67/2852; G06F 17/30117; G06F 17/30174; H04L 67/1097; G06F 17/3028; G06F 17/30876

(57) ABSTRACT

Methods and arrangements are provided for managing, caching and optimizing a media file library on a user device and a cloud media library in a cloud storage space. Once media files are created and stored on the user device, they are uploaded to the cloud storage space. A caching and optimizing strategy is then employed both on the device and the cloud storage space, according to a set of optimization rules. The rules relate to efficiently managing the storage limitations on both the device and the cloud space as needed. Original media files and their cached versions can be dynamically assigned to be automatically deleted from the user device in favor of being uploaded to the cloud space, as device storage space becomes limited. These media files and their cached versions can be automatically re-downloaded from the cloud space to the user device when a user or application requires them.

### TECHNICAL FIELD

The present technology pertains to syncing data in the cloud, and more specifically pertains to syncing, caching, and managing media files on a cloud content library and one or more user devices.

### BACKGROUND

Network-based repositories for storing, syncing, and managing content have become increasingly popular. Such content repositories are capable of syncing content between the “cloud” and one or more devices. This arrangement is well-suited for users, businesses, and other enterprises that share content between multiple electronic devices. One example can be an online image library. A user can take photographs or other images using a portable electronic device, edit the images using a desktop device, and display the images on a tablet computer device. A network-based content repository can be used to store the original digital image files, save edits to them, and share them between devices. In this way, each version of each image file can be accessible in the cloud and can be downloaded to any synced device when a version is needed for that device.

Although cloud-based content libraries have the advantages of storing large amounts of content and making it available on demand across devices, users still have to deal with the reality of storage space limitations on devices. A user wishing, for example, to push the contents of a large image library from the content repository onto a tablet device may realize that the tablet has run out of space. Similarly, a user taking many photographs during an overseas trip may realize that the phone she is taking the pictures on has run out of space. Although the image files on the device are backed up in the cloud network, the device itself cannot take any more photographs. While the user may manually free up space by deleting media files on the device that have been backed up, and otherwise optimize the device to be able to take more photographs, this potentially expends considerable time that the user may not have in the middle of the trip. It also effectively removes the photographer from the experience of having a large or nearly infinite amount of space with which to take photographs. Finally, it may not result in as efficient a use of hard drive space as the photographer could benefit from.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for syncing and efficiently managing media file data between a cloud-based content library and one or more user devices. Media files are generally understood to include photographs, images, video, audio, animated images, and any related images and image file data, as well as any combination of the foregoing. Cloud computing is a type of Internet-based computing in which a variety of resources are hosted and/or controlled by an entity and made available by the entity to authorized users via the Internet. A cloud-based library of resources can communicate with one or more devices via a network. Any user device with a wired network connection, Wi-Fi connection, Bluetooth, or other form of connection to a network can communicate with such a library and exchange information. A cloud-based media library consists of modules and storage spaces for media content such as images, and can synchronize content between devices and the cloud, cache content for efficient usage and storage of that content, and manage content both in the cloud and on the devices. When a photograph is taken with a camera and transferred to storage on a device synced to the cloud content library, the modules within the cloud content library are configured to monitor and receive a signal from the device indicating unsynced media content is present. The media content, i.e. the image file, is then automatically uploaded to the content library. A caching module, located in the cloud or within the device itself or a combination of both, follows a set of caching rules for the image file. Caching entails lowering the resolution of the media file, which in its original form is high resolution. Lowering the resolution makes for practical, storage-efficient and transfer-efficient usage of media files for various activities that a user may engage in on the device. For example, browsing images on an image browser on the device may not require a full resolution image, but editing the image for professional work does. A thumbnail image is also created for user device thumbnail browsing. The set of caching rules looks at current user activity, past user activity, and what a user is likely to do in the near future in order to determine whether a media file should be cached, at which resolution to cache the media file at, and when to transfer the media to the device. In some embodiments, media files that a user has recently taken and media that are frequently viewed by the user merit a set of cached versions to be transferred to the device, based on usage. In embodiments in which audio files are cached, caching entails lowering the audio resolution, corresponding to the number of bits per sample, lowering the sample rate, corresponding to the frequency response, executing audio compression algorithms, or other ways of generating a version of the audio file that is storage-efficient and transfer-efficient. Similarly, video files can be cached by adjusting the video resolution of the file, compressing the file through various compression methods, or others way of generating a version of the video file that is storage-efficient and transfer-efficient.

The cloud content library is capable of more than syncing media content and providing a caching strategy and process for that media content. In addition, the cloud content library can monitor and manage the storage space on the device and in the cloud when storage space becomes low on either. Syncing devices with a cloud library that is capable of large amounts of storage means that local media content is automatically backed up and stored in the cloud without any action from the user. Since the media content is backed up and available on demand of the device or the user, the local device no longer needs to store an entire media library within local storage. The cloud library, when given permission to do so by the device, can remove individual pieces of media content from the user device to free up space within the device. It can also replace high resolution version of media files on the device with lower resolution media files, then delete those high resolution versions to free up space. The effect of these syncing, caching, and storage optimization operations between a device and a cloud library means that, in effect, an “infinite camera roll” is possible, subject only to the scalable cloud storage space provided. Effectively, users are freed to take as many photographs as possible without worrying about the size of local storage space. As long as there is a connection to the cloud library, then storing, caching for use, and removing from local storage all occur seamlessly in the background, without the user experience being interrupted.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary configuration of a cloud computing system;

FIG. 2 illustrates an exemplary configuration of devices, a cloud content library and a network;

FIG. 3 illustrates an exemplary method embodiment of the syncing and caching operations between a device and a cloud content library;

FIG. 4 illustrates an exemplary method embodiment of the storage optimization operations between a device and a cloud content library; and

FIG. 5A and FIG. 5B illustrate exemplary system embodiments.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for the efficient cloud storage, caching, and storage management of media content between one or more user devices and a cloud content library. The disclosed technology provides users with the ability to capture media and transfer media to one or more devices, make use of that media content as if it was stored on a local device, and have the file space management handled by the cloud content library without consideration of local space limitations.

In the following discussion, the words “sync,” “synced,” “syncing,” etc. are used interchangeably with “synchronization.” Both refer to the ability to transfer large amounts of content between a cloud-based content repository and one or more devices, without a user being manually involved in any of the transfer and transmission of the content between devices and cloud. In some embodiments, a user chooses to “opt in” to a syncing arrangement, whereby the transmission and management of content between devices and cloud can happen without further intervention. In some embodiments, a media application on the user device facilitates the synchronization, while in other embodiments, the synchronization functionality is built into the functionality of the device and no additional application is needed.

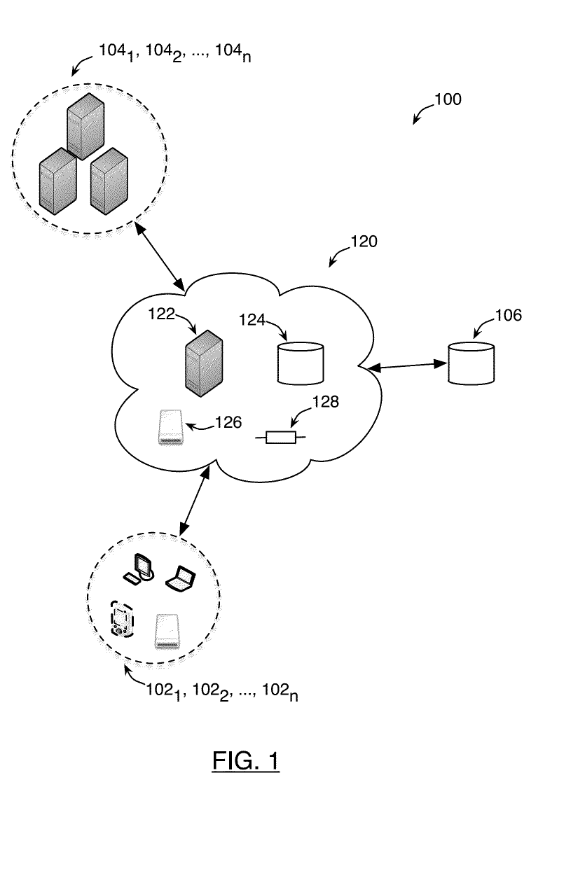

Cloud computing is a type of Internet-based computing in which a variety of resources are hosted and/or controlled by an entity and made available by the entity to authorized users via the Internet. An exemplary cloud computing system configuration 100 is illustrated in FIG. 1 wherein a variety of electronic devices can communicate via a network for purposes of exchanging content and other data. The system can be configured for use on a wide variety of network configurations that facilitate the intercommunication of electronic devices. For example, each of the components of system 100 in FIG. 1 can be implemented in a localized or distributed fashion in a network. A peer-to-peer configuration can exist in some embodiments, allowing for user devices to directly exchange media files and other data through an intermediary hub.

System 100 can be configured to include cloud computing resources 120. The cloud resources can include a variety hardware and/or software resources, such as cloud servers 122, cloud databases 124, cloud storage 126, cloud networks 128, cloud applications, cloud platforms, and/or any other cloud-based resources. In some cases, the cloud resources are distributed. For example, cloud storage 126 can include multiple storage devices. In some cases, cloud resources can be distributed across multiple cloud computing systems and/or individual network enabled computing devices. For example, cloud computing resources 120 can communicate with servers 104₁, 104₂, . . . , 104ₙ (collectively “104”), database 106, and/or any other network enabled computing device to provide the cloud resources.

Furthermore, in some cases, the cloud resources can be redundant. For example, if the cloud computing resources 120 are configured to provide data backup services, multiple copies of the data can be stored such that if one storage resource is unavailable the data will still be available to the user. In another example, if the cloud computing resources 120 are configured to provide software, the software can be available from different cloud servers so that the software can be served from the closest server.

In system 100, a user interacts with the cloud computing resources 120 through user terminals 102₁, 102₂, . . . , 102ₙ (collectively “102”) connected to a network by direct and/or indirect communication. Cloud computing resources 120 can support connections from a variety of different electronic devices, such as servers; desktop computers; mobile computers; handheld communications devices, e.g., mobile phones, smart phones, tablets; set top boxes; network-enabled hard drives; and/or any other network-enabled computing devices. Furthermore, cloud computing resources 120 can concurrently accept connections from and interact with multiple electronic devices.

Cloud computing resources 120 can provide cloud resources through a variety of deployment models, such as public, private, community, hybrid, and/or any other cloud deployment model. In some cases, cloud computing resources 120 can support multiple deployment models. For example, cloud computing resources 120 can provide one set of resources through a public deployment model and another set of resources through a private deployment model.

In some configurations, a user terminal 102ᵢ can access cloud computing resources 120 from any location where an Internet location is available. However, in other cases, cloud computing resources 120 can be configured to restrict access to certain resources such that a resource can only be accessed from certain locations. For example, if cloud computing resources 120 is configured to provide a resource using a private deployment model, then cloud computing resources 120 can restrict access to the resource, such as by requiring that a user terminal 102ᵢ access the resource from behind a firewall.

Cloud computing resources 120 can provide cloud resources to user terminals 102 through a variety of service models, such as Software as a Service (SaaS), Platforms as a service (PaaS), Infrastructure as a Service (IaaS), and/or any other cloud service models. In some cases, cloud computing resources 120 can provide multiple service models to a user terminal 102ᵢ. For example, cloud computing resources 120 can provide both SaaS and IaaS to a user terminal 102ᵢ. In some cases, cloud computing resources 120 can provide different service models to different user terminals 102. For example, cloud computing resources 120 can provide SaaS to user terminal 102₁ and PaaS to user terminal 102₂.

In some cases, cloud computing resources 120 can maintain an account database. The account database can store profile information for registered users. The profile information can include resource access rights, such as software the user is permitted to use, maximum storage space, etc. The profile information can also include usage information, such as computing resources consumed, data storage location, security settings, personal configuration settings, etc.

Cloud computing resources 120 can provide a variety of functionality that requires user interaction. Accordingly, a user interface (UI) can be provided for communicating with cloud computing resources 120 and/or performing tasks associated with the cloud resources. The UI can be accessed via an end user terminal 102ᵢ in communication with cloud computing resources 120. The UI can be configured to operate in a variety of client modes, including a fat client mode, a thin client mode, or a hybrid client mode, depending on the storage and processing capabilities of cloud computing resources 120 and/or the user terminal 102ᵢ. Therefore, a UI can be implemented as a standalone application operating at the user terminal in some embodiments. In other embodiments, a web browser-based portal can be used to provide the UI. Any other configuration to access cloud computing resources 120 can also be used in the various embodiments.

As described above, in some configurations, the cloud computing resources can be used to store user data. The present disclosure contemplates that, in some instances, this gathered data might include personal and/or sensitive data. The present disclosure further contemplates that the entities responsible for the collection, analysis, disclosure, transfer, storage, or other use of such data should implement and consistently use privacy policies and practices that are generally recognized meeting or exceeding industry or governmental requirements for maintaining personal information data private and secure. For example, personal data from users should be collected for legitimate and reasonable uses of the entity and not shared or sold outside of those legitimate uses. Further, such collection should occur only after the informed consent of the users. Additionally, such entities should take any needed steps for safeguarding and securing access to such personal data and ensuring that others with access to the personal data adhere to their privacy and security policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal data. That is, the present disclosure contemplates that hardware and/or software elements can be provided to prevent or block access to such personal data. For example, the present technology can be configured to allow users to select the data that is stored in cloud storage.

Therefore, although the present disclosure broadly covers use of personal data to implement one or more various disclosed embodiments, the present disclosure also contemplates that the various embodiments can also be implemented without the need for accessing such personal data. That is, the various embodiments of the present technology are not rendered inoperable due to the lack of all or a portion of such personal data. For example, non-personal data can be stored in cloud storage.

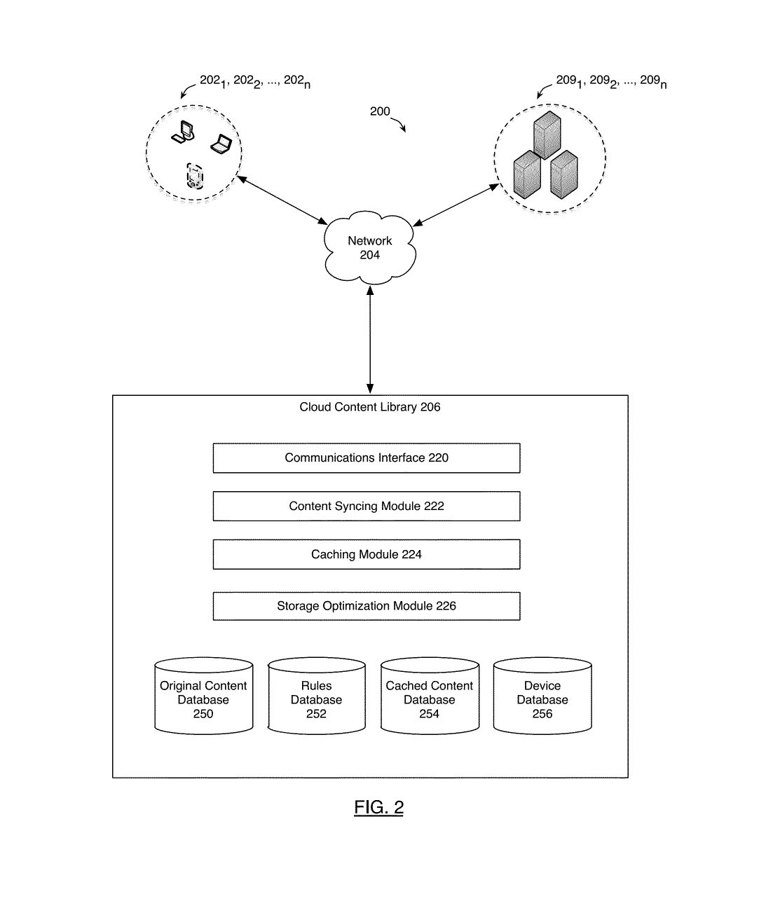

FIG. 2 illustrates a system 200 for caching and optimizing storage space between a device and a cloud content library. The system 200 includes one or more user devices 202₁ . . . 202ₙ, and one or more content repositories 209ᵢ . . . 209ₙ, each in communication with a cloud content library 206 via one or more network 204.

In some embodiments the user devices 202 are each associated with a single user account in the cloud content library 206 and each contain media items. While media items can include any piece of media within a file, media items are generally understood to include photographs, medias, video, audio, animated medias, and any related medias and media file data, as well as any combination of the foregoing.

A user device 202 can include a phone, tablet, desktop computer, camera, or any other device capable of connecting to a network and storing media files. Multiple user devices 202 can apply to the embodiment of system 200, including, for example, a phone 202₁ and a tablet 202₂, both of which are associated with the same user account, have different but overlapping media files stored within the devices, and have a connection to the network 204 and the cloud content library 206.

The cloud content library 206 contains a communications interface 220. The communications interface 220 facilitates communication between the cloud content library 206, the user devices 202, and the content repositories 209, as well as any other devices or components that require communication with the embodied components. The communication between these components will be discussed in greater detail below.

The cloud content library 206 also includes a content syncing module 222. A user device 202 with a network connection to the cloud content library 206 can be configured to “opt in” or “opt out” of a syncing arrangement between the cloud content library 206 and the user device 202. Within the syncing arrangement, the cloud content library 206 controls and hosts a variety of resources. In this embodiment, the resources are media files containing image, photograph, video, audio, and related content. When a user device 202, such as a smart phone, takes a photograph with the built-in camera, that photograph is stored on the user device 202. The syncing arrangement allows for the stored photograph to be uploaded to the cloud content library 206 automatically, without any intervention from the user, as long as there is network connectivity on the user device to connect to the cloud content library 206. In some embodiments, a user device 202 may use another device as a proxy device to connect to the cloud library 206, such as through tethering with a second user device or similar methods of forming an ad hoc network. This syncing allows for a potentially large library of media files, taken by the camera or transferred into the device through other means, to automatically be stored within a cloud-based library, available on demand. At some point in the future, a user may decide to delete the image file from the user device 202. The user can then download that image file from the cloud content library 206 at his or her desire, and restore that image file to the local storage on the user device 202. The user can also transfer the image file from the cloud content library 206 to other devices, such as a tablet or desktop computer, manually or through an automatic syncing arrangement. Syncing allows for intelligent backup and on-demand restoration of media content.

The content syncing module 222 facilitates syncing with the user devices 202 by actively monitoring for signals from the user devices 202. The content syncing module 222 is capable of both uploading content to the cloud library, and downloading content from the cloud library to a user device.

The upload process for the content syncing module 222 is now described. Once a user device 202 sends a signal that a new media file has been detected that has not been uploaded yet, then the content syncing module 222 begins an upload process to upload the file from the user device 202 to the original content database 250. The media file in question is verified by the content syncing module 222 to be an original, full-resolution media file, and if it is, then the content syncing module 222 further verifies that there is enough space within the cloud content library 206 to receive the file. If there is enough space, the upload is executed. Otherwise, the cloud content library sends a message back to the user device 202 that the cloud content library 206 is full and unable to receive more content. In some embodiments, the cloud content library can then run an intelligent optimization of the files stored within the cloud content library, in order to free up storage space. Further discussion of such an optimization procedure is discussed below in regard to the storage optimization module 226.

In some embodiments, in addition to media files being uploaded and stored in the original content database 250, the media files can also be placed within one or more media repositories 209. The cloud content library 206 and the content syncing module 222 can describe and refer to the media files within the media repositories 209 using data objects including identifiers, fingerprints, etc. The media repositories 209 can act as an external storage for the media files that are uploaded to the cloud. In some embodiments, the media repositories 209 can store files in the cloud and replace the original content database 250 entirely.

The content syncing module 222 also employs a method for downloading media files and data from the cloud content library 206 to one or more user devices 202. For example, when media files exist in the cloud, but no media files exist on a user device 202 that is scheduled to be synced (i.e., a clean device), then the following method is used. First, metadata about the media files, or information associated with the media files, is fetched from the original content database 250 via the content syncing module 222, to quickly obtain information about what files are needed in what capacity. The media file metadata can contain a variety of media data, including file size, file resolution, and more. Once this metadata is fetched, or concurrently while the metadata is being fetched, very low resolution versions of the image files are downloaded onto the user device 202, such as thumbnail versions for image content. Thumbnail versions consist of low resolution, small versions of the image content that take up little space and are fast to download. Thumbnail files are useful for certain operating system functions on a user device 202, such as allowing the user to navigate through pictures quickly in a file directory or media browser.

The content syncing module 222 then obtains a set of syncing optimization rules from the rules database 252 and uses the rules to optimize the syncing of files based on the expected usage of the user on the user device 202. The syncing optimization rules are configured to optimize media file version downloads based on what the user is viewing or is likely to view on the device. Syncing optimization rules can vary depending on different embodiments. Some examples of syncing optimization rules follow.

One form of syncing optimization rule involves prioritizing the current user view. If syncing is occurring while the user is navigating a media browser or file navigation system on the user device 202, then various rules can apply to prioritize what the user sees, to provide a seamless media browsing experience. For example, an image that a user is looking at via a thumbnail version of that image is immediately synced, and a version of the image is downloaded from either the original content database 250 or the cached content database 254. Similarly, images above and below within the browser or navigation system, as well as images adjacent to the image the user is currently viewing are downloaded. In order to efficiently provide media files needed within a user experience in real time or substantially real time, some media files may be downloaded as the original version, from the original content database 250, while other media files may have cached versions that are downloaded, from the cached content database 254. For example, if a user currently wants to view a specific file, the original, full-resolution media file may be downloaded to the user device, or a cached, lower resolution version of the media file may be downloaded.

Another example of a syncing optimization rule can involve recent media files. Images or video that have been recently captured with a camera on the user device 202, audio files that have recently been captured with a microphone on the user device 202, or media files that have recently been transferred in from a user device 202 are given priority for downloading to the device. The rule may specify that four weeks is considered recent, for example. All media files taken or transferred in from the past four weeks are considered recent, and are downloaded to the user device in both an original content version and cached content versions.

In other embodiments, syncing optimization rules can give priority to media files based on date created; whether the user marked the media file as a favorite within an app or media browser; whether the user shared the media file with others recently; whether the media file has been edited recently; whether the media file is related in some way to other media files that have been accessed; and more. Since the media files are potentially synced across multiple devices, these criteria can be determined across all devices rather than just one.

The cloud content library 206 contains a caching module 224. The caching module 224 is configured to efficiently cache incoming media files as well as media files that are currently within the cloud content library 206. Caching in this instance refers to taking original, full-resolution media files from the original content database 250 and generating a lower resolution file of the media through processing. Lowering the resolution of a media file leads to decreased file sizes. Some uses of an image file, such as editing, require the use of a full resolution version of the image. Other uses, such as viewing an image on a mobile device, may be best served with lowest file size by displaying a lower resolution version of the image. In some embodiments, caching is only performed once the caching module 224 verifies that an original, full-resolution media file is stored in the cloud.

The caching module 224 can lower the resolution of an original content file to different resolutions, depending on the needs of the components within the cloud content library 206. Syncing optimization rules, described above in relation to the content syncing module 222, may instruct the caching module 224 to generate cached versions and download them to user devices 202. In some embodiments, image files may be cached at a three-megapixel version, twelve-megapixel version, etc. At the lowest end, the image file may be cached at a version that is under one megapixel.

The cloud content library 206 can also contain a storage optimization module 226. The storage optimization module 226 obtains a set of storage optimization rules from the rules database 252 to efficiently manage and optimize the storage of media files across multiple devices. To minimize storage space concerns, the storage optimization module 226 has the ability to monitor the storage space of devices and remove media files that have already been backed up to the cloud, or remove media files when a lower resolution media file is available and appropriate. The storage optimization module 226 opens a background storage space monitoring session with a user device 202 while network connectivity is present on that user device. In some embodiments, the storage optimization module 226 has special activity states and conditions that are triggered when a user device's storage space lowers beyond a specific amount. Categories such as medium, low, very low, and critically low may be designated with a specific percentage or a specific available hard drive space that triggers activity. On a “low” activity setting, the storage optimization rules may instruct the caching module 224 to create lower resolution versions of files to be pushed to the device, and then delete the higher resolution versions of files from the device. On a “critically low” activity setting, meanwhile, media files may be deleted from the user device entirely, rather than lower resolution media files being substituted. The media files may be deleted safely, since the cloud content library 206 keeps storage versions of the media file in the cloud for re-downloading at a later time when needed. On a “medium” activity setting, the storage optimization rules may not stipulate that any critical deletion is needed, but measures are taken to swap out unneeded or unused high-resolution files with lower resolution files from the cached content database 254. Each activity setting can correspond to a different subset of the storage optimization rules that dictates the storage and caching behavior of the cloud content library 206.

In some embodiments, special methods are available for syncing, caching and storing across multiple devices seamlessly. For example, such a situation can include User Device A, User Device B, and the cloud content library 206, all interconnected through network 204. Device A can opt in to a syncing arrangement, and automatically push (or upload) the media file content within its storage space to the cloud content library 206. The cloud content library 206 then sends a signal to Device B, which has opted into a syncing arrangement, informing Device B that new files are available to sync between the cloud and Device B. Device B can thus begin downloading cached content or original content media files from the cloud subsequently or concurrently while Device A is uploaded files to the cloud. This can allow for content to be synced across all three storage spaces intelligently, with caching and storage optimization features working alongside the syncing, and without any manual intervention from the user.

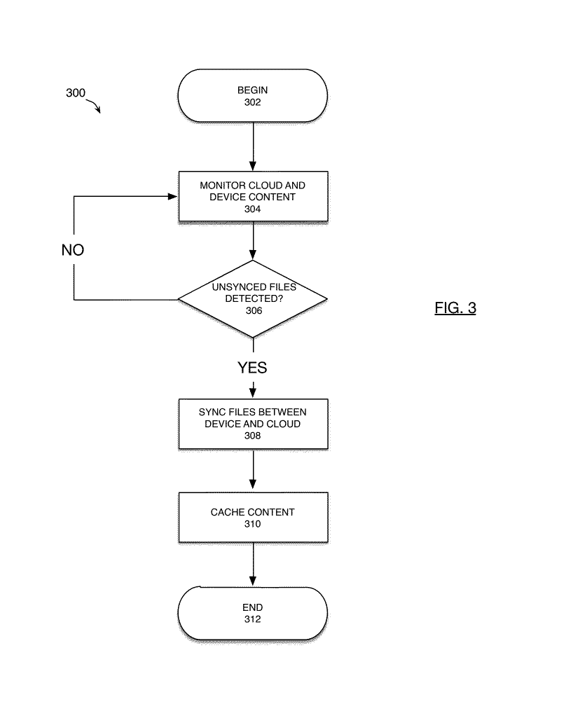

Turning now to FIG. 3, an operation of the syncing and caching between the cloud content library 206 and a user device 202 will be discussed in greater detail. FIG. 3 is a flowchart of steps in an exemplary method 300 for syncing files between the cloud and a user device, and for caching content in the cloud and the user device. For ease of illustration, the steps of method 300 will be described with respect to a server-centric configuration. That is, an embodiment in which a server caches and syncs content to a user device. However, the steps shown in FIG. 2 can be carried in a substantially similar way in embodiments where some or all of the steps for caching and syncing content are performed at a user device, as described above. In one particular example, the caching of content in method 310, discussed below, is performed entirely on the user device in some embodiments.

Method 300 begins at step 302. At step 304, the cloud content library 206 monitors cloud and device activity and content, via content syncing module 222. The monitoring involves a persistent stream of low-processing-level signals received by the content syncing module 222 from the user device 202. The signals provide information to the content syncing module 222 about new media that has been captured by the user device, new media files that have been transferred to the device, what activities the user is performing, what applications are being executed on the device, what is happening on the user's screen, and more.

At method 306, the content syncing module 222 checks if unsynced files are detected on the user device 202. This involves checking whether the signals received during the monitoring indicate unsynced files. For example, if a photograph is just taken on the user device 202, then shortly thereafter a signal will get sent indicating that unsynced media files exist on the device.

If no unsynced files are detected, then method 304 is repeated and monitoring continues. If unsynced files are detected, then at method 308, files are synced between the user device 202 and the cloud content library 206. First, metadata related to the media files are received by the cloud content library 206. The metadata contains information on media file size, media resolution, and other attributes. Based on the media metadata, the content syncing module 222 determines whether enough space exists for the media file to be uploaded, and whether the media file is an original, full resolution media file. The content syncing module 222 then obtains the media file from the user device 202 if both conditions are true.

Using a set of syncing optimization rules from the rules database 252, the content syncing module 222 is able to monitor the user device and be alerted when a condition of the syncing optimization rules is satisfied. For example, when a user is navigating an image file browser and scrolling through thumbnails, the content syncing module 222 receives signals related to that activity. In some cases, the user may be trying to click on image files that are present in the cloud, but are not present on the user device 202. The content syncing module provides the original image file from the original content database 250, or cached image file from the cached content database 254, as needed. The user device can then download that file and the user will be able to access it from the user device. In some situations, activity can signal in a predictive way what a user is about to do. For instance, if the user is browsing an adjacent image file, then the content syncing module 222 can proactively download the image file with correct resolution from the cloud to the user device 202.

At method 310, the caching module 224 caches the media file or media files that were uploaded to the cloud in method 308. Caching, as discussed above, involves creating lower resolution versions of the original media file that was uploaded. A set of caching rules dictate what resolutions files should be cached in. For example, one set of caching rules may instruct the caching module 224 to create versions of the image file at three megapixels, nine megapixels and twelve megapixels. The monitoring and signals received from method 306 also instruct the caching module to create and send cached media files to the user device 202 as needed. For example, a user sharing an image file via email may trigger a request from the user device 202 for a three megapixel version of the image file. The caching module 224 then creates the cached three megapixel version, if such a version does not exist, and sends it to the user device 202 for storage and access. The effect is that when a specific version of a media file is requested from the user device 202, it can be obtained in substantially real time or with only a short delay.

At method 312, the operation ends. In most embodiments, the operation can repeat indefinitely, starting again at method 302.

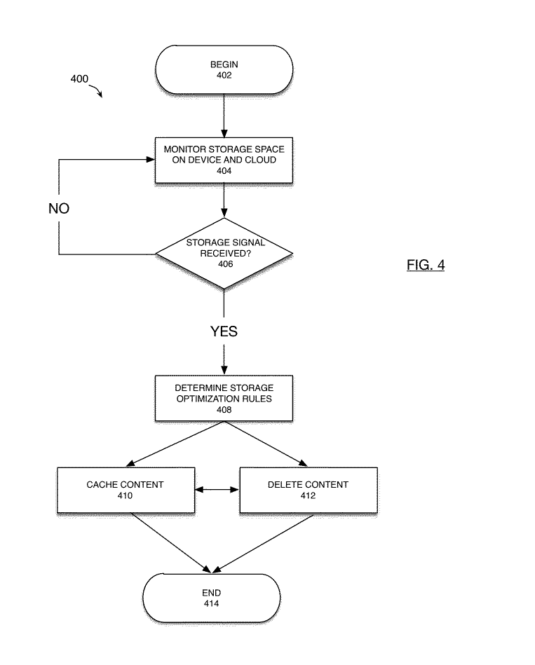

FIG. 4 illustrates an operation of storage optimization performed by a cloud content library. FIG. 4 is a flowchart of steps in an exemplary method 400 for optimizing and efficiently managing the storage space on a user device 202. At method 402, the operation begins. At method 404, the storage optimization module 226 monitors the storage space of a user device that the cloud content library 206 is authorized to sync with. Monitoring consists of a set of signals that are sent to the cloud content library 206 from the user device 202 when a user device's storage space is lowered beyond a specific threshold. Many such thresholds can exist, and are dictated by a set of storage optimization rules. Examples of thresholds that may trigger signals in differing embodiments include the storage space dropping below 30 GB, dropping below 10 GB, dropping below 5 GB, and at a critical level, dropping below 500 MB.

At method 406, the cloud content library 206 checks if any storage signals have been received. If not, then the monitoring continues at method 404. If a signal is received, then the operation moves on to method 408.

At method 408, the storage optimization module 226 determines the storage optimization rules that apply to the interaction between the user device 206 and the cloud content library 206. The storage optimization module 226 obtains the set of storage optimization rules from the rules database 252. The storage optimization rules provide instructions for how to handle situations in which specific signals are sent from the user device 206, indicating storage space has dropped below a certain threshold. Different thresholds are handled by the storage optimization module 226 in different ways, according to the specific rules for those thresholds within the storage optimization rules. As discussed above, a ‘medium’ storage space signal may involve caching some content and removing full resolution media files from the device, while a ‘low’ storage space signal may involve deleting content without replacing it with cached content.

Depending on the signal received and the storage optimization rules, the operation then moves into one of two procedures. If the storage optimization rules instruct the storage optimization module 226 to cache content, then the operation moves to method 410. At method 410, the storage optimization module 226 first determines one or more media files that a user has not used recently and which are stored in the user device 202. The storage optimization module 226 then generates a lower resolution version of that media file, or locates a lower resolution version of that media file within the cached content database 254. The storage optimization module 226 then sends this version to the user device 202. Next at method 412, the storage optimization module 226 deletes the original media file from the user device 202 to free up storage space.

Alternatively, if the storage optimization rules instruct the storage optimization module 226 to delete content without caching, then the operation moves to method 412, bypassing method 410. At method 412, the storage optimization module 226 deletes the indicated original media file from the user device 202 to free up storage space. The operation then ends at method 414. In some embodiments, the operation can repeat indefinitely and start again at method 402.

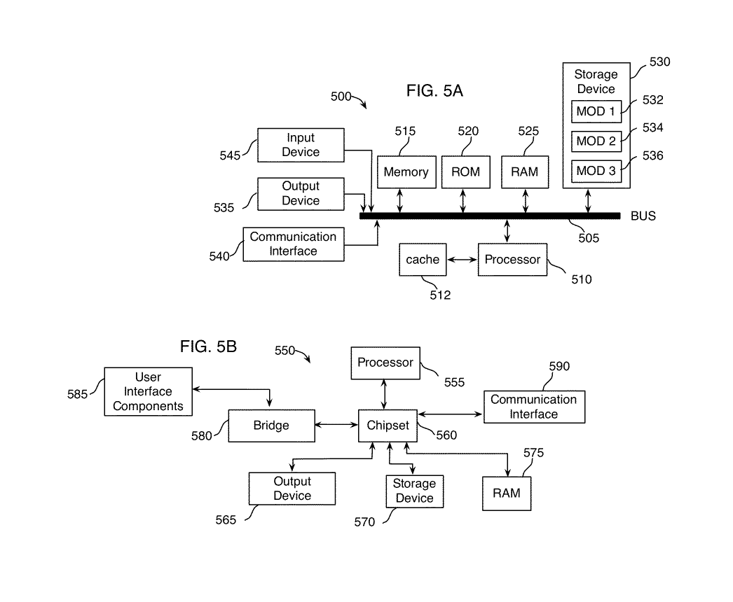

FIG. 5A, and FIG. 5B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 5A illustrates a conventional system bus computing system architecture 500 wherein the components of the system are in electrical communication with each other using a bus 505. Exemplary system 500 includes a processing unit (CPU or processor) 510 and a system bus 505 that couples various system components including the system memory 515, such as read only memory (ROM) 520 and random access memory (RAM) 525, to the processor 510. The system 500 can include a cache of high-speed memory connected directly with, in close proximity to, or integrated as part of the processor 510. The system 500 can copy data from the memory 515 and/or the storage device 530 to the cache 512 for quick access by the processor 510. In this way, the cache can provide a performance boost that avoids processor 510 delays while waiting for data. These and other modules can control or be configured to control the processor 510 to perform various actions. Other system memory 515 may be available for use as well. The memory 515 can include multiple different types of memory with different performance characteristics. The processor 510 can include any general purpose processor and a hardware module or software module, such as module 1 532, module 2 534, and module 3 536 stored in storage device 530, configured to control the processor 510 as well as a special-purpose processor where software instructions are incorporated into the actual processor design. The processor 510 may essentially be a completely self-contained computing system, containing multiple cores or processors, a bus, memory controller, cache, etc. A multi-core processor may be symmetric or asymmetric.

To enable user interaction with the computing device 500, an input device 545 can represent any number of input mechanisms, such as a microphone for speech, a touch-sensitive screen for gesture or graphical input, keyboard, mouse, motion input, speech and so forth. An output device 535 can also be one or more of a number of output mechanisms known to those of skill in the art. In some instances, multimodal systems can enable a user to provide multiple types of input to communicate with the computing device 500. The communications interface 540 can generally govern and manage the user input and system output. There is no restriction on operating on any particular hardware arrangement and therefore the basic features here may easily be substituted for improved hardware or firmware arrangements as they are developed.

Storage device 530 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 525, read only memory (ROM) 520, and hybrids thereof.

The storage device 530 can include software modules 532, 534, 536 for controlling the processor 510. Other hardware or software modules are contemplated. The storage device 530 can be connected to the system bus 505. In one aspect, a hardware module that performs a particular function can include the software component stored in a computer-readable medium in connection with the necessary hardware components, such as the processor 510, bus 505, display 535, and so forth, to carry out the function.

FIG. 5B illustrates a computer system 550 having a chipset architecture that can be used in executing the described method and generating and displaying a graphical user interface (GUI). Computer system 550 is an example of computer hardware, software, and firmware that can be used to implement the disclosed technology. System 550 can include a processor 555, representative of any number of physically and/or logically distinct resources capable of executing software, firmware, and hardware configured to perform identified computations. Processor 555 can communicate with a chipset 560 that can control input to and output from processor 555. In this example, chipset 560 outputs information to output 565, such as a display, and can read and write information to storage device 570, which can include magnetic media, and solid state media, for example. Chipset 560 can also read data from and write data to RAM 575. A bridge 580 for interfacing with a variety of user interface components 585 can be provided for interfacing with chipset 560. Such user interface components 585 can include a keyboard, a microphone, touch detection and processing circuitry, a pointing device, such as a mouse, and so on. In general, inputs to system 550 can come from any of a variety of sources, machine generated and/or human generated.

Chipset 560 can also interface with one or more communication interfaces 590 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 555 analyzing data stored in storage 570 or 575. Further, the machine can receive inputs from a user via user interface components 585 and execute appropriate functions, such as browsing functions by interpreting these inputs using processor 555.

It can be appreciated that exemplary systems 500 and 550 can have more than one processor 510 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

We hereby claim:

1. A computer-implemented method, comprising:
obtaining at least one image file from a user device;
determining a plurality of cached image files to be generated from the at least one image file, based on a set of caching optimization rules, wherein the set of caching optimization rules corresponds to past usage of image files on the user device;
sending, to the user device, an instruction to compress the image resolution of the at least one image file to generate the plurality of cached image files, based on the set of caching optimization rules;
monitoring the storage space on the user device; and
sending, to the user device, an instruction to delete the at least one image file from the user device when the storage space of the user device reaches a storage space threshold, wherein the storage space threshold is a specified amount of storage space on the user device.

2. The method of claim 1, wherein the sending the instruction to compress the image resolution of the at least one image file comprises lowering the image resolution of the at least one image file to a second image resolution, and wherein the second image resolution is determined by the set of caching optimization rules.

3. The method of claim 1, wherein the monitoring the storage space on the user device comprises receiving information from the user device related to the size of the storage space.

4. The method of claim 1, wherein the obtaining at least one image file from the user device comprises receiving the at least one image file from the user device via a synchronization connection between the user device and a network-based content repository.

5. The method of claim 1, further comprising establishing a synchronization connection between the user device and a network-based content repository.

6. The method of claim 1, further comprising sending at least one of the plurality of cached image files to the user device.

7. The method of claim 6, wherein the sending the at least one of the plurality of cached image files is based on a set of storage optimization rules.

8. The method of claim 1, wherein the sending the instruction to delete the image file from the user device is based on a set of storage optimization rules.

9. The method of claim 1, wherein image files comprise visual data in the form of a photograph, image, graphic, animation, video, or any combination thereof.

10. The method of claim 1, further comprising obtaining image metadata from the user device.

11. A computer-readable medium storing computer executable instructions for causing a computer to perform the method comprising:
obtaining at least one image file from a user device;
determining a plurality of cached image files to be generated from the at least one image file, based on a set of caching optimization rules, wherein the set of caching optimization rules corresponds to past usage of image files on the user device;
sending, to the user device, an instruction to compress the image resolution of the at least one image file to generate the plurality of cached image files, based on the set of caching optimization rules;
monitoring the storage space on the user device; and
sending, to the user device, an instruction to delete the at least one image file from the user device when the storage space of the user device reaches a storage space threshold, wherein the storage space threshold is a specified amount of storage space on the user device.

12. The computer-readable medium of claim 11, further comprising establishing a synchronization connection between the user device and a network-based content repository.

13. The computer-readable medium of claim 11, further comprising sending at least one of the plurality of cached image files to the user device.

14. The computer-readable medium of claim 13, wherein the sending the at least one of the plurality of cached image files is based on a set of storage optimization rules.

15. The computer-readable medium of claim 11, wherein the sending the instruction to delete the image file from the user device is based on a set of storage optimization rules.

16. A product comprising:
a computer readable medium; and
computer readable instructions, stored on the computer readable medium, that when executed are effective to cause a computer to:
establish a synchronization connection with a user device;
monitor image file content on the user device;
receive a first image file from the user device;
generate a second image file from the first image file by sending an instruction to the user device to lower the resolution according to a set of caching optimization rules;
send the second image file to the user device; and
send an instruction to delete the first image file from the user device.

17. The product of claim 16, wherein the synchronization connection comprises an automatic transferring of content between the computer and the user device via a network connection.

18. The product of claim 16, wherein the set of caching optimization rules comprises instructions for generating lower resolution images on the user device based on user activity on the user device.

19. A computer-implemented method, comprising:
synchronizing with a user device via a network connection;
obtaining at least one image file from the user device, wherein the at least one image file is an original, full-resolution image;
determining a plurality of cached image files to be generated from the at least one image file, based on a set of caching optimization rules, wherein the set of caching optimization rules corresponds to past usage of image files on the user device;
sending, to the user device, an instruction to compress the image resolution of the at least one image file to generate the plurality of cached image files, based on the set of caching optimization rules;
monitoring the storage space on the user device;
sending at least one of the plurality of cached image files to the user device; and
sending, to the user device, an instruction to delete the at least one image file from the user device when the storage space of the user device reaches a storage space threshold, wherein the storage space threshold is an amount of storage space on the user device specified by a set of storage optimization rules.

20. The method of claim 19, further comprising obtaining image metadata from the user device.

21. The method of claim 19, wherein the sending the at least one of the plurality of cached image files is based on a set of storage optimization rules.

22. The method of claim 19, wherein the sending the instruction to delete the image file from the user device is based on a set of storage optimization rules.

23. The method of claim 19, wherein image files comprise visual data in the form of a photograph, image, graphic, animation, video, or any combination thereof.
